(19) United States
(12) Patent Application Publication
(10) Pub. No.: US 2026/0261438 A1
(43) Pub. Date: Sep. 3, 2026

(54) Dynamic Frequency Shifting Security System

(71) Applicant: Reza Tadayon, Washington, DC (US)

(72) Inventor: Reza Tadayon, Washington, DC (US)

(21) Appl. No.: 19/544,851

(22) Filed: Feb. 19, 2026

Related U.S. Application Data
(60) Provisional application No. 63/765,672, filed on Mar. 2, 2025.

(51) Int. Cl. H04L 9/32; G10K 15/02

(52) U.S. Cl. CPC H04L 9/3271; G10K 15/02

(57) ABSTRACT

A dynamic frequency shifting security system uses acoustic waveforms for replay-resistant authentication. A transmitter generates rolling material deterministically from a shared secret and a varying reference such as a time window or receiver challenge, and emits an acoustic waveform whose instantaneous frequency behavior is determined by the rolling material. A receiver captures the waveform, performs time-resolved spectral analysis to estimate a sequence of frequency descriptors forming an observed trajectory, generates an expected trajectory using the same shared secret and varying reference, and compares observed to expected under tolerance and/or scoring rules to grant access. In a challenge-response mode, the receiver emits an acoustic challenge used by the transmitter to generate a response waveform, reducing time synchronization needs.

### CROSS-REFERENCE TO RELATED APPLICATIONS

This nonprovisional application claims the benefit of U.S. Provisional Patent Application No. 63/765,672, filed Mar. 3, 2025, entitled "Dynamic Frequency Shifting Security System (DFSS)," pursuant to 35 U.S.C. § 119(e). The entire contents of the provisional application are incorporated herein by reference.

### INCORPORATION BY REFERENCE

Other than the provisional application identified above, no material is incorporated by reference into this application.

### BACKGROUND OF THE INVENTION

Field of the Invention. The present disclosure relates to security and authentication systems and, more particularly, to access control using acoustic authentication in which a time-varying or challenge-varying frequency pattern is generated from shared secret material and verified using real-time signal analysis.

Description of Related Art. Many access control systems rely on radio-frequency (RF) technologies, such as RFID, NFC, Bluetooth, and Wi-Fi. In various deployment conditions, RF-based credentials may be susceptible to interception, relay, cloning, replay, or other attacks, particularly where authentication signals are static or otherwise predictable.

Acoustic authentication can provide physical-layer benefits in some use cases because acoustic propagation is typically short-range and can be more difficult to relay covertly without introducing latency, distortion, or detectable artifacts. However, acoustic approaches that transmit fixed tones or static encodings may still be vulnerable to recording and replay.

There is therefore a need for an acoustic authentication system that (i) produces freshness at the physical layer, (ii) varies the acoustic behavior over time or per authentication attempt, and (iii) can be verified robustly under noise and device variation while mitigating replay, relay, and cloning threats.

### BRIEF SUMMARY OF THE INVENTION

The present disclosure provides a Dynamic Frequency Shifting Security System (DFSS) that uses shared secret material and a varying reference, including at least one of a time window, a counter, an event, and a receiver-provided challenge, to deterministically generate a continuously varying or pseudo-randomly varying acoustic frequency pattern used as an authentication primitive.

In one embodiment, the DFSS includes a transmitter unit and a receiver unit. The transmitter unit generates rolling material (e.g., cryptographically generated rolling material) based at least in part on a shared secret and a varying reference such as a time reference, and maps the rolling material to an instantaneous acoustic frequency or a frequency trajectory to produce a short authentication burst. The authentication burst may be in an audible band, an ultrasonic band, or both.

In certain embodiments, the transmitted acoustic waveform is not packetized and is not intended to convey a discrete message payload that is demodulated into reusable credential data. Instead, authentication is performed by trajectory extraction and matching of physical-layer behavior of the waveform, including an instantaneous-frequency trajectory or other frequency descriptor sequence, against an expected trajectory derived from the same shared secret material and varying reference.

The receiver unit captures the acoustic waveform and performs time-resolved spectral analysis to estimate one or more frequency descriptors over successive windows, thereby forming an observed trajectory. The receiver independently computes an expected trajectory using the shared secret and the varying reference, and compares the observed trajectory to the expected trajectory using tolerance rules and/or scoring logic. Access is granted upon a match or sufficient score.

In an advanced embodiment, the DFSS includes a challenge-response mode in which the receiver emits an acoustic challenge and the transmitter generates response material using the challenge as an input, optionally in place of the time reference. In such embodiments, time synchronization may be reduced or eliminated because the challenge supplies freshness.

### BRIEF DESCRIPTION OF THE DRAWINGS

FIG. 1 is a system overview of an exemplary DFSS including a transmitter unit and a receiver unit that communicate via an acoustic authentication waveform, with an optional receiver-to-transmitter challenge.

FIG. 2 is a block diagram of an exemplary transmitter unit.

FIG. 3 is a block diagram of an exemplary receiver unit.

FIG. 4 is a flow diagram of an exemplary one-way authentication process.

FIG. 5 is a flow diagram of an exemplary challenge-response authentication process.

### DETAILED DESCRIPTION OF THE INVENTION

The following description is provided to enable a person of ordinary skill in the art to make and use the disclosed subject matter. The disclosed embodiments are illustrative and not limiting. Various modifications and alternative forms will be apparent. The functional blocks and process steps shown in the drawings are schematic and may be combined, separated, reordered, and/or omitted for clarity; for example, expected trajectory generation may be performed by an expected trajectory generation module (e.g., module 237) prior to trajectory matching/authentication (e.g., module 240), and in some implementations may be integrated within the trajectory matching/authentication functionality.

As used herein, "acoustic" includes audible frequencies and ultrasonic frequencies. "Ultrasonic" generally refers to frequencies above approximately 20 kHz. "Rolling material" refers to a time-varying or attempt-varying value generated deterministically using a shared secret and a varying reference. In some embodiments, the rolling material is generated using cryptographic primitives (e.g., pseudo-random functions), but cryptographic generation is not required in all embodiments. The varying reference may include a timestamp, time window index, counter, event count, receiver challenge, or combinations thereof.

Unless the context requires otherwise, "comprising" is open-ended and permits additional elements or steps.

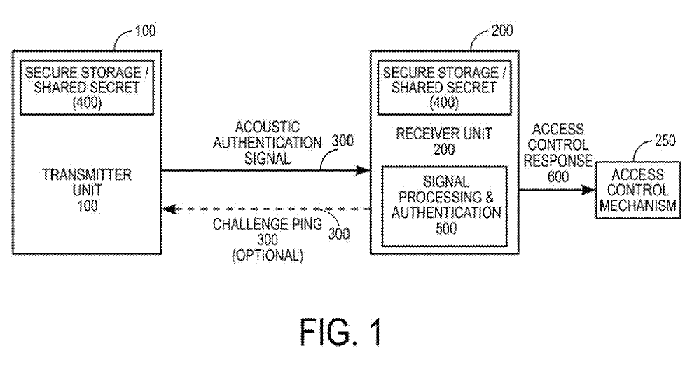

System Overview. Referring to FIG. 1, a DFSS 10 includes a transmitter unit 100 and a receiver unit 200. The transmitter unit 100 emits an acoustic authentication waveform 300 that is received by the receiver unit 200. Based on analysis of the received waveform, the receiver unit 200 generates an access control response 600 to actuate or enable an access control mechanism 250. In some embodiments, the receiver unit 200 includes processing circuitry (e.g., a signal processing and authentication module 500) configured to process the captured acoustic waveform and perform trajectory-based authentication as described herein.

In some embodiments, the transmitter unit 100 and the receiver unit 200 each include secure local storage for a shared secret and configuration parameters (e.g., within a secure element, trusted execution environment, hardware security module, or other secure storage), such secure local storage being represented as a secure storage / shared secret module 400. In certain embodiments, the shared secret and configuration parameters are provisioned into the module 400 during manufacturing, pairing, or enrollment, after which the DFSS 10 is operable offline without requiring network connectivity or periodic key updates. In a mobile transmitter embodiment, the shared secret may be provisioned one time via an application and, in some cases, via a cloud-assisted enrollment channel, and then stored locally for subsequent offline operation.

In some embodiments, the receiver unit 200 optionally transmits an acoustic challenge ping 300 to the transmitter unit 100 for challenge-response operation. In certain implementations, the challenge-response exchange may be initiated by a trigger event at the transmitter unit 100 (e.g., actuation of trigger mechanism 110), causing the transmitter unit 100 to emit a predetermined initiation ping or preamble that is detected by the receiver unit 200 as a trigger to emit the acoustic challenge ping. In such embodiments, the transmitter unit 100 may include a microphone or other acoustic sensor to capture the challenge ping for use in response generation.

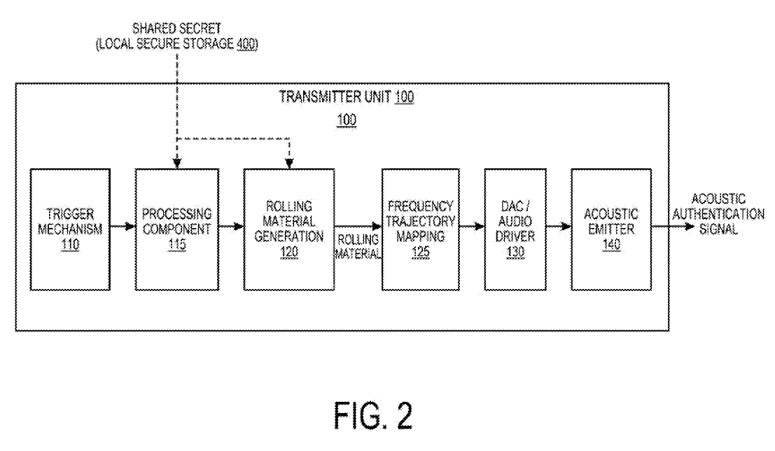

Transmitter Unit. Referring to FIG. 2, the transmitter unit 100 may include a trigger mechanism 110, a processing component 115, a rolling material generator 120, a frequency trajectory mapping module 125, an audio driver 130, and an acoustic emitter 140. In challenge-response embodiments, the transmitter unit 100 may further include a microphone or other acoustic sensor (not shown) configured to capture a challenge ping emitted by the receiver unit 200.

The trigger mechanism 110 initiates an authentication attempt responsive to an event such as a user actuation, motion detection, proximity detection, capacitive touch, or a command from a host device.

Rolling Material Generation. In embodiments, the generator 120 produces rolling output bytes or values using the shared secret and a varying reference. Non-limiting examples of implementations include a pseudo-random function (PRF) or a stream cipher construction (e.g., AES in CTR mode or ChaCha20) to provide strong unpredictability. For clarity, in certain embodiments, the rolling output may be used to drive generation of the acoustic authentication waveform and its frequency-trajectory behavior, rather than to encrypt or encode a message payload for subsequent decryption or demodulation.

In certain embodiments, the rolling output used to determine acoustic behavior may be generated using a pseudo-random number generator (PRNG), chaotic function, or other deterministic sequence generator, including non-cryptographic generators where lower security is acceptable or where hardware constraints favor lightweight computation.

In some embodiments, the shared secret may be evolved using a ratcheting mechanism, for example by hashing the secret after each successful authentication interval. Ratcheting is optional; in other embodiments a static secret with time- or counter-based variation is used.

Frequency Trajectory Mapping Module. The frequency trajectory mapping module 125 converts rolling output into an instantaneous acoustic frequency f(t) or other frequency descriptor of the emitted waveform. In one embodiment, the mapping is deterministic and continuous, producing a continuously varying frequency trajectory over a short burst interval.

Pseudo-Random Frequency Selection. In an important embodiment, a next transmitted frequency is selected pseudo-randomly using rolling output as a seed. For example, for each time window or sub-window, a deterministic pseudo-random selection chooses a frequency from a permitted set within a selected band.

Additional Mapping Examples. Mapping may be linear or non-linear and may include scaling, offsetting, polynomial transforms, spline-based mappings, logarithmic or exponential scaling, lookup-table mappings, piecewise functions, or chaotic modulation.

Update Rate. Frequency updates may occur once per authentication attempt, at fixed time intervals within a burst, and/or continuously during a short authentication burst.

Acoustic Output. The authentication system may operate using audible frequencies, approximately 20 Hz to 20 kHz, ultrasonic frequencies, or combinations thereof. In certain embodiments, the emitted acoustic waveform is an analog waveform whose instantaneous frequency trajectory reflects rolling output but is not structured as packetized data intended to be demodulated into a reusable credential code.

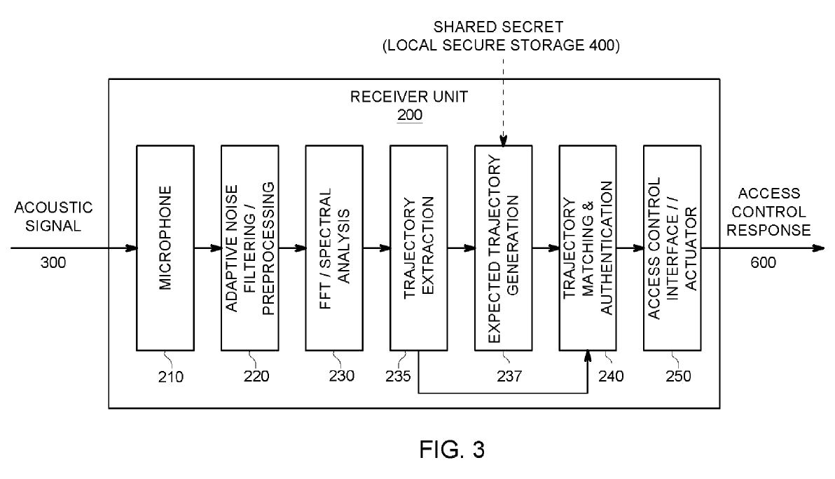

Receiver Unit. Referring to FIG. 3, the receiver unit 200 may include a microphone 210, a preprocessing module 220, a time-resolved spectral analysis module 230, a frequency descriptor extraction / trajectory extraction module 235, an expected trajectory generation module 237, a trajectory matching/authentication module 240, and an access control interface/actuator 250. The shared secret may be stored in local secure storage 400 and provided to the expected trajectory generation module 237 and/or the trajectory matching/authentication module 240. In embodiments, the expected trajectory generation module 237 may be implemented as a distinct functional block (as schematically shown) or integrated within the trajectory matching/authentication module 240. In challenge-response embodiments, the receiver unit 200 may further include challenge generation and/or trajectory mapping circuitry configured to generate the acoustic challenge ping 300 (e.g., by selecting a random frequency and/or mapping a random value to a short ping waveform), a digital-to-analog converter (DAC) and/or audio driver, and an acoustic emitter (e.g., a speaker or transducer) configured to output the acoustic challenge ping toward the transmitter unit 100.

Signal Capture and Preprocessing. The microphone 210 captures ambient sound containing the authentication waveform. The preprocessing module 220 may apply band-pass filtering, gain control, noise suppression, echo mitigation, and normalization. Sampling rates may be selected to support ultrasonic capture.

Time-Resolved Spectral Analysis. The module 230 performs time-frequency analysis to extract spectral information from the captured waveform. In embodiments, analysis includes FFT processing over successive windows. In other embodiments, frequency estimation may be performed using cepstral analysis, harmonic modeling, autoregressive spectral estimation, MUSIC/ESPRIT parametric analysis, autocorrelation-based estimation, or machine-learned models.

Frequency Descriptor Extraction / Trajectory Extraction / Observed Trajectory. The module 235 produces an observed sequence of frequency descriptors over time, including dominant frequency, instantaneous frequency, spectral centroid, phase-derived frequency, or chirp rate. The observed descriptor sequence forms an observed trajectory.

Expected Trajectory Generation. The receiver unit independently computes an expected trajectory using the same shared secret and varying reference model used by the transmitter. In embodiments, expected trajectory generation is performed by an expected trajectory generation module 237 and may be combined with trajectory matching/authentication (e.g., module 240) in certain implementations. In time-window embodiments, both units compute rolling output for a current time window and optionally one or more adjacent windows.

Trajectory Matching / Authentication. The module 240 compares the observed trajectory to the expected trajectory using one or more acceptance rules. In embodiments, the module applies frequency tolerance bands, timing tolerance, and noise-adaptive thresholding based on ambient conditions.

In some embodiments, matching is computed using absolute distance, Euclidean difference, correlation scoring, dynamic time warping, or probabilistic scoring. In some embodiments, the module evaluates derivative features including frequency gradient, curvature, slope, second-order derivative, or local variance to improve robustness.

Upon a match or sufficient score, the receiver unit generates an access control response 600 and actuates or signals the access control mechanism 250.

Synchronization and Resynchronization. In time-window embodiments, the transmitter and receiver independently compute rolling output for the current time window. The receiver may check the current window and one or more adjacent windows to tolerate clock drift. If authentication fails due to drift, resynchronization may occur automatically upon a subsequent attempt without transmitting explicit timing data; larger drifts may be corrected by manual resynchronization.

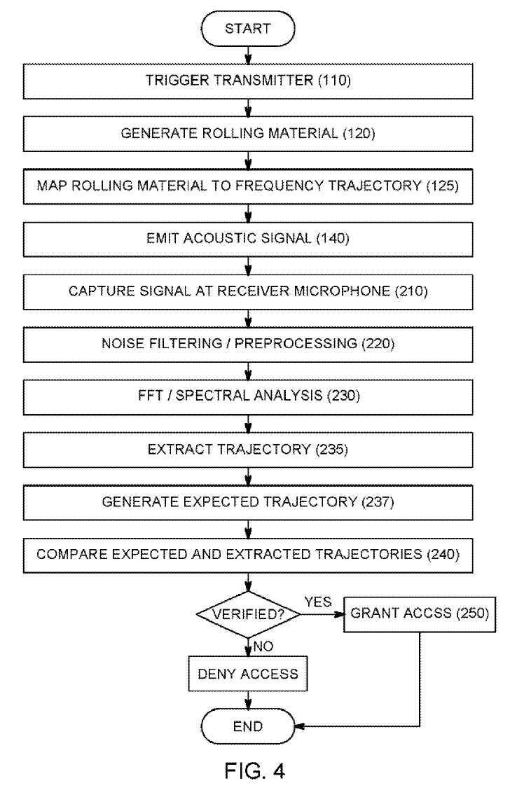

One-Way Authentication Process. Referring to FIG. 4, an example one-way process includes: triggering the transmitter (110); generating rolling material (120); mapping the rolling material to an acoustic frequency trajectory (125); emitting the acoustic signal (140); capturing the signal at the receiver microphone (210); performing noise filtering and/or preprocessing (220); performing FFT and/or other time-resolved spectral analysis (230); extracting an observed trajectory (235); generating an expected trajectory (237); comparing the expected and observed trajectories under tolerance and/or scoring rules (240); and granting or denying access based on the comparison (250).

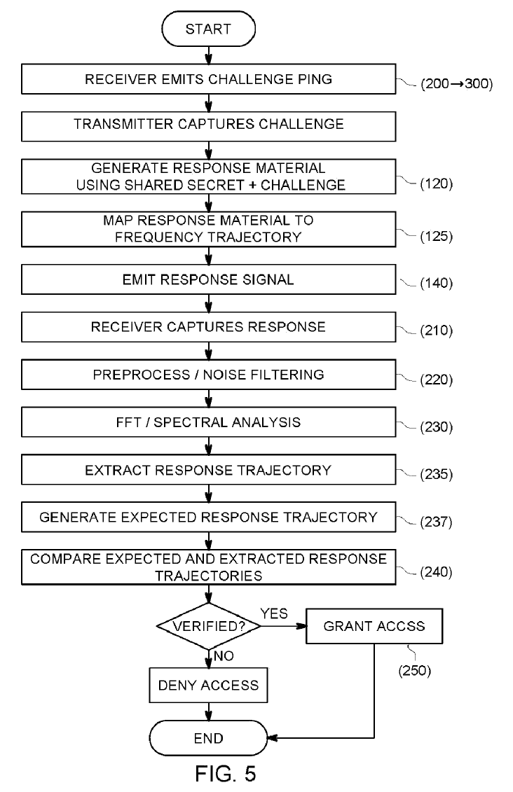

Challenge-Response Authentication Process. Referring to FIG. 5, the receiver unit 200 emits an acoustic challenge ping 300 including a randomly selected frequency or short ping. In embodiments, the receiver unit 200 may generate and output the acoustic challenge ping 300 using challenge generation and/or trajectory mapping circuitry together with a DAC/audio driver and an acoustic emitter (e.g., a speaker or transducer). In certain implementations, the challenge-response exchange may be initiated by a trigger event at the transmitter unit 100 (e.g., actuation of trigger mechanism 110) causing the transmitter unit 100 to emit a predetermined initiation ping or preamble that is detected by the receiver unit 200 as a trigger to emit the acoustic challenge ping 300. The transmitter captures the challenge (e.g., using a microphone or other acoustic sensor), generates response material using the shared secret and the challenge (120), maps the response material to a frequency trajectory (125), including by pseudo-randomly selecting a next transmitted frequency using the response material as a seed and/or by applying a deterministic mapping function (linear or non-linear) to map the response material to an instantaneous acoustic frequency, and emits an acoustic response signal (140). The receiver captures the response (210), performs preprocessing and/or noise filtering (220) and time-resolved spectral analysis (230), extracts an observed response trajectory (235), generates an expected response trajectory (237) derived from the shared secret and the challenge, compares the expected and observed response trajectories (240), and grants or denies access based on the comparison (250). In some embodiments, the comparison comprises computing a score based on at least one of absolute distance, Euclidean difference, correlation scoring, and dynamic time warping. In embodiments, the receiver grants access only if the comparison satisfies one or more acceptance rules, such as a frequency tolerance band, a timing tolerance, and/or a noise-adaptive threshold. In a particular embodiment, the challenge replaces a time reference in rolling generation, thereby reducing or eliminating time synchronization requirements.

Replay and Relay Mitigation. The use of varying references, including time windows and receiver challenges, and deterministic but changing trajectories limits the usefulness of recorded waveforms. The receiver may enforce timing constraints to reduce feasibility of relay attacks.

Example Implementations. In a smart lock, the receiver unit is integrated with a lock actuator and the transmitter unit is implemented as a portable fob or phone accessory. In an automotive deployment, the receiver unit is integrated with a vehicle access or ignition module. In an enterprise deployment, the receiver unit is integrated with a door controller or network authenticator.

The functional components described herein may be implemented in hardware, firmware, software, or combinations thereof. Features described in one embodiment may be combined with other embodiments unless the context indicates otherwise.

What is claimed is:

1. A security system comprising: a transmitter unit configured to generate rolling material as a deterministic function of at least (i) a shared secret and (ii) a varying reference, and to generate and emit an acoustic authentication waveform having an instantaneous frequency behavior determined based on the rolling material; and a receiver unit configured to capture the acoustic authentication waveform, perform time-resolved spectral analysis to estimate a sequence of frequency descriptors for the captured waveform as an observed frequency trajectory, generate an expected frequency trajectory based on the shared secret and the varying reference, compare the observed frequency trajectory to the expected frequency trajectory under at least one acceptance rule, and grant access upon the comparison satisfying at least one acceptance rule.

2. The security system of claim 1, wherein the varying reference comprises a time window index, and wherein the receiver unit is configured to evaluate at least a current time window and one adjacent time window to tolerate clock drift.

3. The security system of claim 1, wherein the transmitter unit is configured to select a next transmitted frequency pseudo-randomly using the rolling material as a seed.

4. The security system of claim 1, wherein the transmitter unit is configured to map rolling material to an instantaneous acoustic frequency using a deterministic mapping function that is linear or non-linear.

5. The security system of claim 1, wherein the acoustic authentication waveform is generated as a non-packetized analog waveform that is not intended to be demodulated into a reusable credential code.

6. The security system of claim 1, wherein the instantaneous frequency behavior updates once per authentication attempt, at fixed intervals within an authentication burst, or continuously during the authentication burst.

7. The security system of claim 1, wherein the transmitter unit emits at least a portion of the acoustic authentication waveform in an ultrasonic frequency band.

8. The security system of claim 1, wherein the transmitter unit emits at least a portion of the acoustic authentication waveform in an audible frequency band.

9. The security system of claim 1, wherein the at least one acceptance rule comprises at least one of a frequency tolerance band, a timing tolerance, and a noise-adaptive threshold.

10. The security system of claim 1, wherein comparing comprises computing a score based on at least one of absolute distance, Euclidean difference, correlation scoring, and dynamic time warping.

11. The security system of claim 1, wherein comparing comprises evaluating at least one derivative feature of the observed frequency trajectory, including at least one of slope, curvature, and local variance.

12. A method for acoustic authentication comprising: generating, at a transmitter, rolling material as a deterministic function of at least (i) a shared secret and (ii) a varying reference; generating and emitting an acoustic authentication waveform having an instantaneous frequency behavior determined based on the rolling material; capturing the acoustic authentication waveform at a receiver; performing time-resolved spectral analysis to estimate an observed frequency trajectory for the captured waveform; generating an expected frequency trajectory based on the shared secret and the varying reference; comparing the observed frequency trajectory to the expected frequency trajectory under at least one acceptance rule; and granting access upon the comparison satisfying at least one acceptance rule.

13. The method of claim 12, wherein performing time-resolved spectral analysis comprises performing FFT processing over successive windows to estimate a dominant frequency per window.

14. The method of claim 12, wherein performing time-resolved spectral analysis comprises using at least one of short-time Fourier transforms, cepstral analysis, harmonic modeling, autoregressive spectral estimation, MUSIC/ESPRIT parametric analysis, autocorrelation-based estimation, and machine-learned frequency extraction.

15. The method of claim 12, wherein comparing comprises applying a noise-adaptive threshold based on ambient conditions measured by the receiver.

16. The method of claim 12, wherein the varying reference comprises at least one of (i) a time window index and (ii) an acoustic challenge emitted by the receiver and captured by the transmitter, and wherein, when the varying reference comprises the time window index, the receiver evaluates at least one adjacent time window for drift tolerance.

17. A challenge-response security system comprising: a receiver unit configured to emit an acoustic challenge; and a transmitter unit configured to capture the acoustic challenge, generate response material as a deterministic function of at least (i) a shared secret and (ii) the acoustic challenge, and to emit an acoustic response waveform having an instantaneous frequency behavior determined based on the response material; wherein the receiver unit is further configured to capture the acoustic response waveform, estimate an observed response trajectory using time-resolved spectral analysis, generate an expected response trajectory based on the shared secret and the acoustic challenge, compare the observed response trajectory to the expected response trajectory under at least one acceptance rule, and grant access upon the comparison satisfying at least one acceptance rule.

18. The challenge-response security system of claim 17, wherein the acoustic challenge comprises a randomly selected challenge frequency.

19. The challenge-response security system of claim 17, wherein the transmitter unit is configured to select a next transmitted frequency pseudo-randomly using the response material as a seed.

20. The challenge-response security system of claim 17, wherein the transmitter unit is configured to map response material to an instantaneous acoustic frequency using a deterministic mapping function that is linear or non-linear.

21. The challenge-response security system of claim 17, wherein the acoustic challenge replaces a time reference such that time synchronization between the transmitter unit and the receiver unit is reduced or eliminated.

22. The challenge-response security system of claim 17, wherein the acoustic response waveform is generated as a non-packetized analog waveform that is not intended to be demodulated into a reusable credential code.

23. The challenge-response security system of claim 17, wherein the at least one acceptance rule comprises at least one of a frequency tolerance band, a timing tolerance, and a noise-adaptive threshold.

24. The challenge-response security system of claim 17, wherein comparing comprises computing a score based on at least one of absolute distance, Euclidean difference, correlation scoring, and dynamic time warping.
